(19) United States
(12) Patent Application Publication
(10) Pub. No.: US 2026/0236238 A1
(43) Pub. Date: Aug. 13, 2026

(54) PROGRAM, INFORMATION PROCESSING METHOD, AND INFORMATION PROCESSING DEVICE

(71) Applicant: NEUROBASE, INC., Tokyo (JP)

(72) Inventor: Yasuhiro INUMA, Tokyo (JP)

(21) Appl. No.: 19/146,670

(22) PCT Filed: Oct. 26, 2023
(86) PCT No.: PCT/JP2023/038663

§ 371 Date: Feb. 23, 2026

(30) Foreign Application Priority Data
Apr. 21, 2023 (JP) 2023-070344

(51) Int. Cl. G06F 8/35

(52) U.S. Cl. CPC G06F 8/35

(57) ABSTRACT

Provided are a program and the like that make it possible to design and develop software without requiring software design skills or development skills. According to this program, a computer receives an overview prompt indicating an overview of a program code to be generated. The computer enters the received overview prompt into a natural language processing model to obtain a detailed prompt indicating detailed specification content regarding the program code. The computer then enters the obtained detailed prompt into the natural language processing model to obtain the program code.

### TECHNICAL FIELD

The present disclosure relates to a computer program, an information processing method, and an information-processing apparatus.

### BACKGROUND ART

Patent Document 1 discloses a technique for designing screens of software having a graphical user interface (GUI) through a graphical interface, by selecting pre-prepared parts, arranging the selected parts, and setting attribute information and configuration items. By using such a technique, even engineers who do not possess advanced screen-design skills can easily design execution screens in software.

### PRIOR ART DOCUMENTS

Patent Document 1: Japanese U.S. Pat. No. 6,570,436

### SUMMARY OF INVENTION

### Problem to be Solved by the Invention

In recent years, software versions and specifications change rapidly, and higher design and development speeds for software are demanded. Accordingly, there is a need for a system that enables software to be designed and developed without requiring higher software design skill or development skill.

One aspect of the present disclosure aims to provide a program and the like that make it possible to design and develop software without requiring software design skill or development skill.

### Means for Solving the Problem

According to one aspect, a program of the present disclosure causes a computer to execute processing that: accepts an outline prompt indicating an outline regarding program code to be generated; inputs the accepted outline prompt into a natural-language processing model to acquire a detailed prompt indicating detailed specification regarding the program code; and inputs the acquired detailed prompt into the natural-language processing model to acquire the final program code.

### Advantageous Effects of the Invention

In one aspect, software can be designed and developed without requiring higher software design skill or development skill.

### BRIEF DESCRIPTION OF DRAWINGS

FIG. 1 is a block diagram illustrating an example configuration of an information-processing apparatus of the present disclosure.

FIG. 2 is a flowchart illustrating an example procedure of processing for generating program code.

FIG. 3 is a flowchart illustrating another example procedure of processing for generating program code.

FIG. 4 is a flowchart illustrating still another example procedure of processing for generating program code.

FIG. 5 is a flowchart illustrating yet another example procedure of processing for generating program code.

FIG. 6 is a flowchart illustrating a further example procedure of processing for generating program code.

FIG. 7A is a schematic view for explaining an example screen.

FIG. 7B is a schematic view for explaining an example screen.

FIG. 8 is a schematic view for explaining an example screen.

FIG. 9 is a schematic view for explaining an example screen.

FIG. 10A is a schematic view for explaining an example screen.

FIG. 10B is a schematic view for explaining an example screen.

FIG. 11 is a schematic view for explaining an example screen.

FIG. 12 is a schematic view for explaining an example screen.

FIG. 13 is a schematic view for explaining an example screen.

FIG. 14 is a flowchart illustrating an example procedure of processing for generating program code according to Embodiment 2.

FIG. 15 is a schematic view for explaining a modification of an app-design screen.

FIG. 16 is a flowchart illustrating an example procedure of processing for generating program code according to Embodiment 3.

### DETAILED DESCRIPTION OF EMBODIMENTS

Embodiments of the present disclosure will be described in detail below with reference to the drawings.

### Embodiment 1

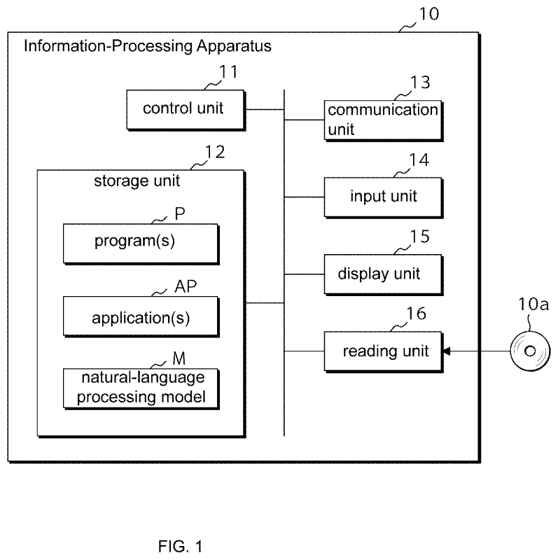

In the present embodiment, an information-processing apparatus is described that performs design and development of an application program (software, hereinafter simply referred to as an “application”) in accordance with instructions (prompts) expressed in natural language (text data) and images. The information-processing apparatus of the present embodiment can support not only the users' work of designing an application but also the users' work of developing the application. Hereinafter, design and development of an application are collectively referred to as “application design.” Although Japanese is used as the natural language in the present embodiment, the natural language is not limited to Japanese; other languages such as English, French, Vietnamese, and Chinese may be used. FIG. 1 is a block diagram illustrating an example configuration of such an information-processing apparatus.

The information-processing apparatus 10 is a computer capable of various information processing and information transmission/reception, and may be a server computer or a personal computer. The information-processing apparatus 10 includes a control unit 11, a storage unit 12, a communication unit 13, an input unit 14, a display unit 15, a reading unit 16, and the like, and these units are interconnected via a bus. The control unit 11 is configured using one or more processors such as a CPU (Central Processing Unit), MPU (Micro-Processing Unit), GPU (Graphics Processing Unit), GPGPU (General-purpose computing on graphics processing units), TPU (Tensor Processing Unit), or an Al chip (Al-dedicated semiconductor). By appropriately executing a program(s) P stored in the storage unit 12, the control unit 11 performs various information-processing and control-processing that the information-processing apparatus 10 is expected to perform. Note that, when the control unit 11 includes a plurality of processors, the control unit 11 may cause each processor to execute its respective processing.

The storage unit 12 includes RAM (Random Access Memory), flash memory, a hard-disk drive, an SSD (Solid State Drive), and the like. The storage unit 12 stores the program P (program product) executed by the control unit 11 and various data necessary for executing the program P. The storage unit 12 also stores an application(s) (hereinafter referred to as a “design-support app AP”) for realizing processing that supports generation (design) of program code for an application. The storage unit 12 temporarily stores data and the like that are generated when the control unit 11 executes the program P and the design-support app AP. The storage unit 12 further stores a natural-language processing model M. The natural-language processing model M is a general-purpose large-language model (LLM) constructed by unsupervised pre-training on a large corpus of texts and the like. The natural-language processing model M is trained so that, when input data—including natural language text data and/or image data—is supplied, it performs computation based on the input data to generate output data corresponding to the content of the input, and outputs the generated data. The natural-language processing model M can be implemented using algorithms such as GPT (Generative Pre-trained Transformer)-3, GPT-3.5, GPT-4, or RWKV, and may also be implemented by combining multiple algorithms. The natural-language processing model M is not limited to transformer-based models forementioned or to recurrent-neural-network (RNN)-based models. The natural-language processing model M is expected to be used as a program module that constitutes artificial-intelligence software. It executes predetermined operations on the input data and outputs the results; coefficients, thresholds, and other parameters defining these operations are stored in the storage unit 12 as elements of the natural-language processing model M. Instead of being stored locally in the storage unit 12, the natural-language processing model M may reside on a separate language-processing server that stores the model and be remotely accessed by the information-processing apparatus 10.

The communication unit 13 is a communication module that performs processing related to wired or wireless communication, and transmits and receives information with other devices via a network. The network may be the Internet or a public switched telephone network, or may be a local area network (LAN) within a facility in which the information-processing apparatus 10 is installed. The input unit 14 accepts operation inputs from a user and sends control signals corresponding to the operation to the control unit 11. The input unit 14 includes, for example, a keyboard and mouse, and a microphone for voice input. The display unit 15 is a liquid-crystal display or an organic EL display, and displays various information according to instructions from the control unit 11. A part of the input unit 14 and the display unit 15 may be an integrated touch panel.

The reading unit 16 reads information stored on a portable storage medium 10a, such as a Compact Disc (CD), Digital Versatile Disc (DVD), Universal Serial Bus (USB) memory, or Secure Digital (SD) card. The program P and the design-support app AP stored in the storage unit 12 may be read by the control unit 11 from the portable storage medium 10a via the reading unit 16 and then stored in the storage unit 12. Alternatively, the program P and the design-support app AP may be written into the storage unit 12 during manufacture of the information-processing apparatus 10, or the control unit 11 may download them from another device via the communication unit 13 and store them in the storage unit 12.

In the present embodiment, the information-processing apparatus 10 may be a multicomputer composed of multiple physical computers, or it may be one or more virtual machines constructed virtually by software within a single device. When the information-processing apparatus 10 is implemented as a server computer, it may be a local server installed in the facility where the information-processing apparatus 10 is located, or a cloud server that is connected via a network such as the Internet. Unless stated otherwise, the following description assumes that the information-processing apparatus 10 is a single computer. The program P and the design-support app AP may be executed on a single computer or may be distributed and executed on multiple computers interconnected via a network. Moreover, the information-processing apparatus 10 does not necessarily require the input unit 14 or the display unit 15; user operations may be accepted through a connected computer, and information to be displayed may be output to an external display device.

With the above configuration, when generating program code, the information-processing apparatus 10 accepts at least one of (i) text data written in natural language, (ii) text data converted from voice data spoken in natural language, and (iii) image data—each describing an outline of the program code to be generated. This input data, which describes an outline of the program code, is hereinafter referred to as the “outline prompt”. The information-processing apparatus 10 executes processing to generate a detailed prompt (hereinafter referred to as an “intermediate prompt”) written in natural language, which describes detailed specifications related to the program code to be generated, based on the received outline prompt using the natural-language processing model M. The apparatus then uses the natural-language processing model M to execute processing that generates program code from the intermediate prompt. Thus, in the present embodiment, the information-processing apparatus 10 employs the natural-language processing model M both when generating the intermediate prompt from the outline prompt and when generating the program code from the intermediate prompt. The information-processing apparatus 10 is further configured to accept editing of the intermediate prompt via at least one of natural language text data, text data converted from speech spoken in natural language, and image data, and to update (modify) the program code by inputting the edited intermediate prompt to the natural-language processing model M. In addition, the information-processing apparatus 10 in the present embodiment accepts intermediate prompts and generates program code from the accepted intermediate prompts; accepts, via a GUI, setting information and other parameters for the program code to be generated; and generates program code based on the accepted settings and the like.

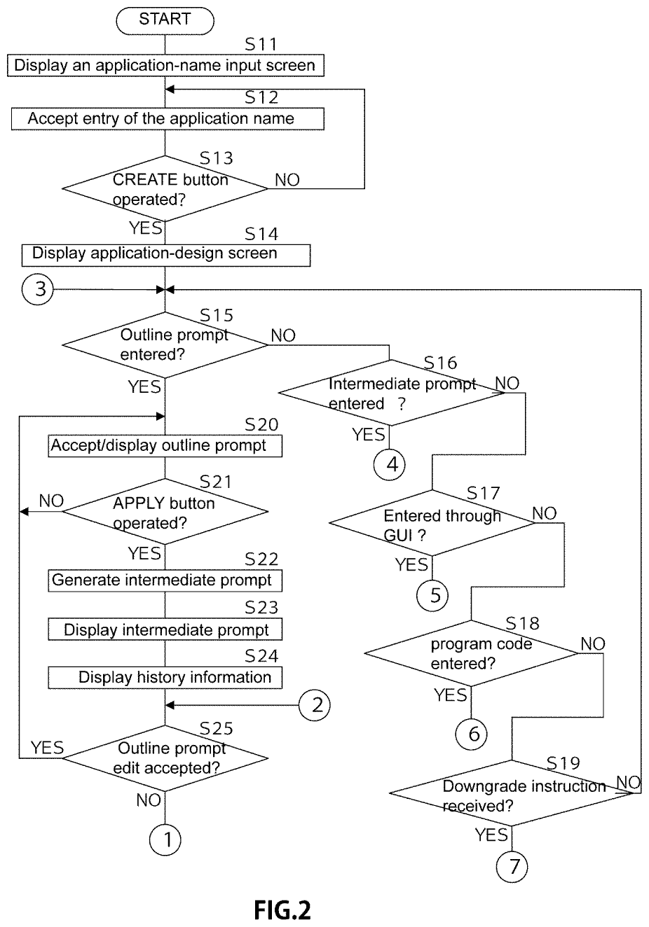

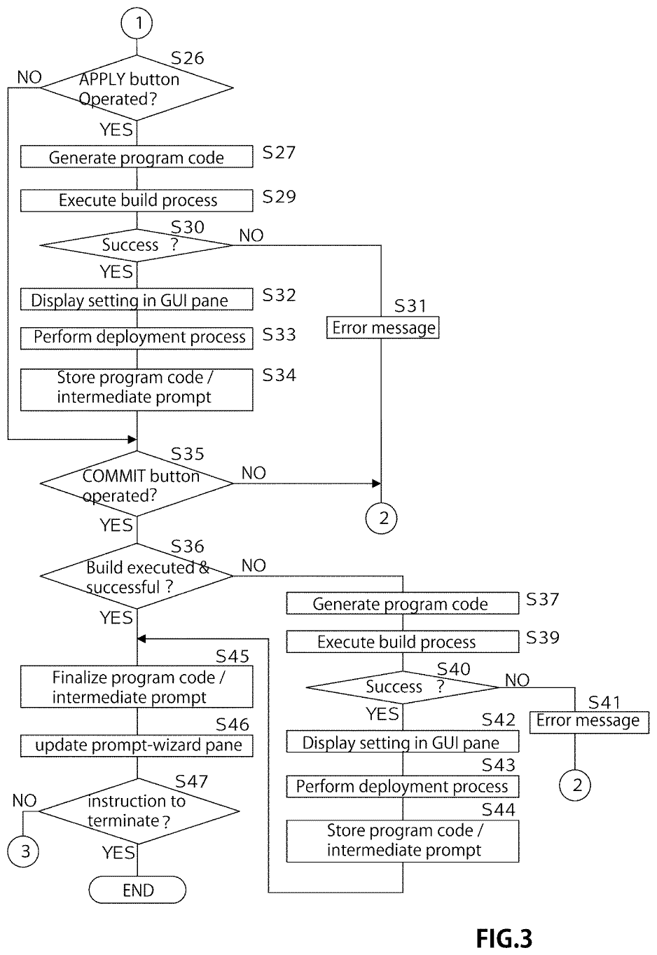

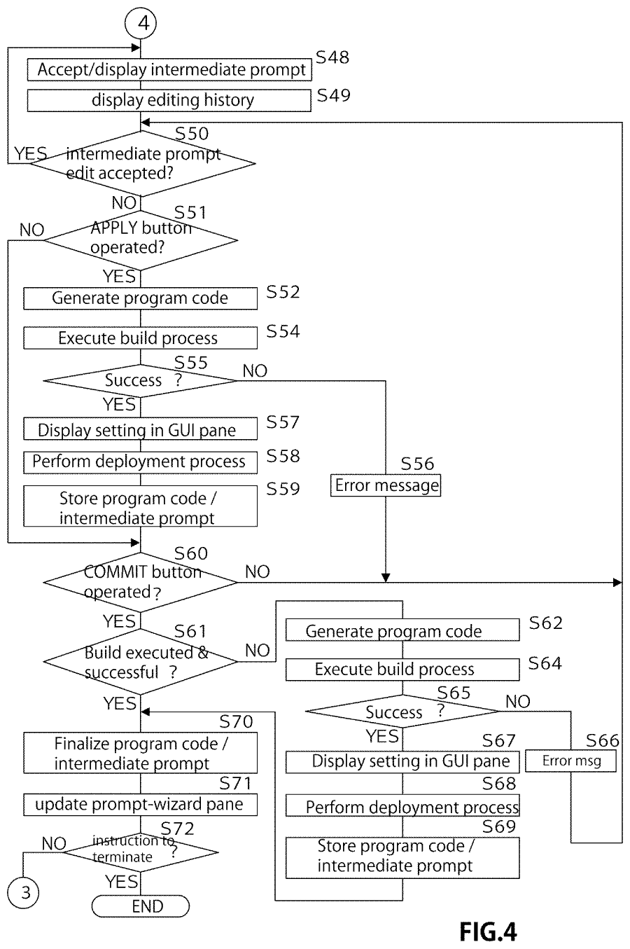

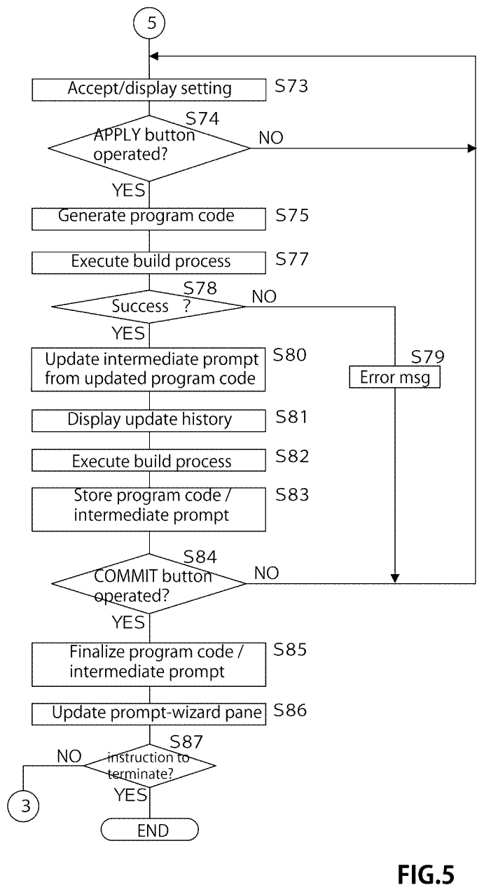

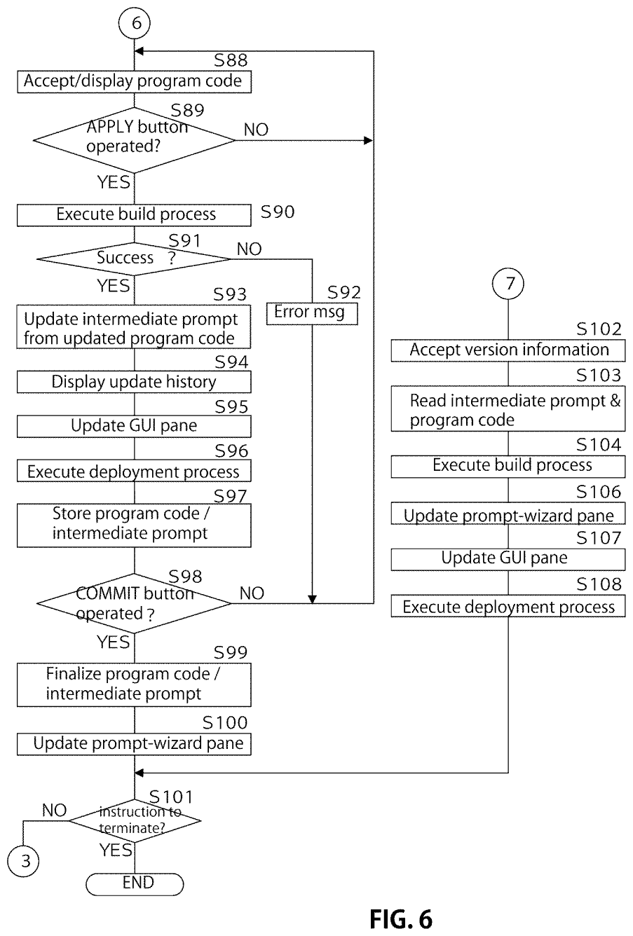

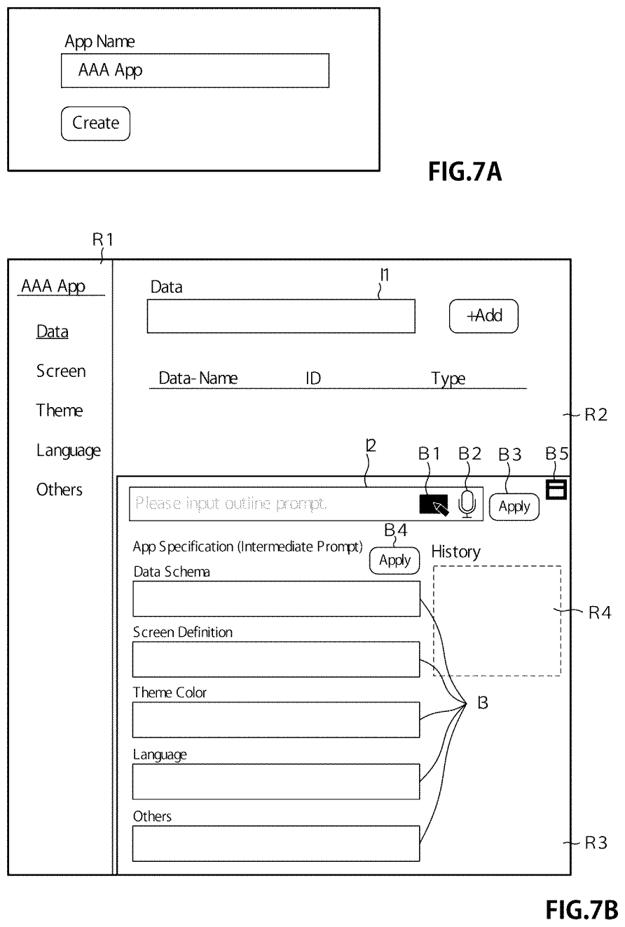

The processing by which the information-processing apparatus 10 of the present embodiment generates program code will now be described. FIGS. 2-6 are flowcharts illustrating an example procedure for generating program code, and FIGS. 7A-13 are explanatory drawings showing example screens. The following processing is executed by the control unit 11 of the information-processing apparatus 10 in accordance with the program P and the design-support app AP stored in the storage unit 12.

A user who designs an application (i.e., generates program code) instructs the information-processing apparatus 10 to launch the design-support app AP. When the control unit 11, via the input unit 14, receives an instruction to launch the design-support app AP, it starts the app and carries out the processing described below.

Upon launching the design-support app AP, the control unit 11 first displays, as an initial screen, a screen (not shown) on the display unit 15 that contains (i) a button for accepting an instruction to create a new application and (ii) a button for accepting an instruction to continue (update) creation of an application already in progress. When the control unit 11 receives, via this initial screen, an instruction to create a new application, it displays an application-name input screen on the display unit 15 (step S11). For example, it shows the screen illustrated in FIG. 7A, which includes an input field for the application name to be given to the new application and a “Create” button for instructing the start of generation of the application having the entered name. The application-name input screen may also include, in addition to the application-name input field, input fields for meta-information such as a description of the application to be created. The control unit 11 accepts, via the input unit 14, entry of the application name in the input field on the application-name input screen (step S12). When the control unit 11 receives the application name, it displays the entered name in the input field.

The control unit 11 determines whether the “Create” button on the application-name input screen has been operated (step S13). If it determines that the button has not been operated (S13: NO), the process returns to step S12 and continues to accept entry of the application name in the input field. If the control unit 11 determines that the “Create” button has been operated (S13: YES), it displays, on the display unit 15, an application-design screen for the new application (S14). For example, it shows the application-design screen depicted in FIG. 7B. The screen in FIG. 7B is a design screen that accepts operations for designing an application whose name is “AAA App.” This screen includes a menu pane R1, a GUI pane R2, and a prompt-wizard pane R3. The menu pane R1 displays menu items that allow the user to select settings that can be applied to the application being generated. In the example of FIG. 7B, the menu items “Data,” “Screen,” “Theme,” “Language,” and “Others” are shown. The menu items are not limited to those in FIG. 7B and may be changed (added or deleted) for each user or for each target application. The system may also be configured so that, for example, “Data” and “Screen” are mandatory items while the other menu items can be freely modified, or any other arrangement may be adopted.

The GUI pane R2 is an area that accepts, through a graphical interface, entry of setting information for each item that can be configured in the application. When any menu item displayed in the menu pane R1 is selected, the GUI pane R2 switches to and displays the screen for entering the setting information corresponding to that selected item. FIG. 7B illustrates the display when the menu item “Data” is selected. In this context: “Data” is a menu item for entering setting information related to the data handled by the application; “Screen” is a menu item for entering setting information related to the display screens in the application; “Theme” is a menu item for entering setting information related to the application's theme colors; “Language” is a menu item for entering setting information related to the languages used in the application; and Others” is a menu item for entering setting information concerning items other than the above.

In the GUI pane R2 shown in FIG. 7B, an input field I1 is provided for entering the name of data to be newly created (for example, a database), together with a “+Add” button for instructing creation of the database having the name entered in the input field I1. When the name of a database is entered in the input field I1 and the “+Add” button is operated, the control unit 11 of the information-processing apparatus 10 displays an input screen (not shown) for entering information on the new database, and, via that screen, accepts entry of information pertaining to the database. This input screen includes, for example, entry fields for (i) the type of database (e.g. its intended use), (ii) the names of the data fields held by the database, and, (iii) the type of data stored (alphabetic characters, numerals, symbols, etc.) for each data field, and (iv) the number of digits, and (v) the data size for each data field. When entry of information on the new database is accepted through such an input screen, the control unit 11 terminates display of the input screen and displays, in the GUI pane R2, the information entered for the database. Because FIG. 7B shows the initial state of the application-design screen, nothing is displayed in the GUI pane R2; however, once information about a database has been entered, items such as the database name (“Data-Name”), the ID assigned to that database, and the database type (“Type”) are displayed, for example. When setting information for each menu item is entered via the GUI pane R2, the control unit 11 of the information-processing apparatus 10 displays the entered setting information in the prompt-wizard pane R3.

The prompt-wizard pane R3 is an area that accepts setting information for each configurable item of the application via inputs expressed in natural language and/or images, and it includes an outline prompt field I2, an intermediate-prompt field I3, and the like. Because FIG. 7B shows the initial state, both the outline prompt field I2 and the intermediate-prompt field I3 are blank. Outline prompt field I2 is an input field that accepts, in natural language text, images, and/or voice input, an outline prompt describing the overview and purpose of the application to be generated. In addition, the outline prompt field I2 is configured to accept, in natural language, images, and/or voice input, execution instructions directed to the control unit 11 of the information-processing apparatus 10 under the design-support app AP, such as: an instruction to modify an already-generated intermediate prompt, an instruction to modify already-generated program code, an instruction to commit the program code currently being created, or an instruction to execute a build process for the program code. Intermediate-prompt field I3 is a preview field that displays, in natural language, a detailed specification (intermediate prompt) of the application to be generated and allows the displayed content to be edited (changed). In the present embodiment, the intermediate-prompt field I3 shows, for each menu item, the specification (intermediate prompt) generated—using the natural-language processing model M—from the outline prompt entered in the outline prompt field I2. The intermediate-prompt field I3 can also accept direct entry of an intermediate prompt via the input unit 14, and it displays both intermediate prompts generated from outline prompts and those entered directly. Specifically, a separate intermediate-prompt field I3 is provided for each menu item displayed in the menu pane R1, and it displays information on the settings for that item. In the example of FIG. 7B: the “Data Schema” intermediate-prompt field I3 shows information related to the “Data” menu item—for example, the structure of databases used in the application (database type, data-field names, data types, etc.), the “Screen Definition” intermediate-prompt field I3 shows information related to the “Screen” menu item—for example, the composition of application screens and screen transition (routing) specifications, the “Theme Color” intermediate-prompt field I3 shows information related to the “Theme” menu item—for example, specifications of the theme colors applied throughout the application, the “Language” intermediate-prompt field I3 shows information related to the “Language” menu item—for example, the languages used in the application, the “Others” intermediate-prompt field I3 shows information related to the “Others” menu item—namely, setting information for items that the user wishes to define in addition to the above specifications. Each intermediate-prompt field I3 is configured to accept editing (changes) to the intermediate prompt displayed therein via natural language text, images, and/or voice input. The configuration of the intermediate-prompt fields I3 is not limited to the example in FIG. 7B, nor must it strictly correspond one-to-one with the menu items. For example, an intermediate-prompt field I3 for “Language” may be omitted, and information on the “Language” menu item may instead be shown in the “Others” intermediate-prompt field I3. When menu items are later changed, the prompt-wizard pane R3 automatically provides intermediate-prompt fields I3 corresponding to the changed menu items.

In the prompt-wizard pane R3 shown in FIG. 7B, the outline prompt field I2 is configured to accept text input via the input unit 14. It is also capable of receiving an outline prompt for the application through image input or voice input from a microphone; for this purpose, an image-input button B1 and a voice-input button B2 are provided. When the image-input button B1 is operated, the control unit 11 of the information-processing apparatus 10 displays a selection screen (not shown) for choosing an arbitrary image file stored in the storage unit 12 or the like, and, through that screen, accepts selection of an image file that contains the application outline. Such an image file includes text—written in natural language—depicting the outline; for example, it may be an image of handwritten notes that has been scanned. The image file may also contain text data in addition to the image, or it may consist of visual information that cannot be converted to natural language text, such as imagery generated by an image-generation Al that produces images from textual prompts. When the voice-input button B2 is operated, the control unit 11 captures sound with the microphone of the input unit 14, acquires the voice data uttered by the user, performs speech-recognition processing on the acquired data to generate text that represents the spoken content, and obtains that generated text as the outline prompt. The outline prompt field I2 may instead be configured to accept a text file in which the application outline is written as text data, or it may accept outline prompts in any kind or format of data, including video files, PDF files, or binary files. Furthermore, the outline prompt field I2 can be arranged to receive outline prompts interactively. For example, the field can display questions about the outline; the user enters answers to those questions, thereby providing the outline prompt. Alternatively, after the user inputs an outline prompt, the control unit 11 may input the prompt to the natural-language processing model M, display output data returned by the model as a response, and permit the user to enter additional outline prompts based on that response, thereby continuing the outline-prompt input process.

In the prompt-wizard pane R3 of FIG. 7B, an Apply button B3 is provided associated with the outline prompt field I2; pressing this button invokes execution of processing that generates an intermediate prompt based on the outline prompt entered in the outline prompt field I2. Similarly, an Apply button B4 is provided in association with each intermediate-prompt field I3; pressing this button invokes execution of processing that generates program code from the intermediate prompt displayed in that field. A screen-switch button B5 is also provided, enabling the user to switch the display region of the GUI pane R2 and the prompt-wizard pane R3 so that only the prompt-wizard pane R3 is shown in a larger view. The prompt-wizard pane R3 further includes a history-display pane R4 that presents update-history information for intermediate prompts. When an intermediate prompt is generated or modified on the basis of an outline prompt entered in the outline prompt field I2, the generation history or modification history of that intermediate prompt is displayed in the history-display pane R4. When an intermediate prompt is entered or edited in an intermediate-prompt field I3, the input or modification history of that prompt is likewise displayed. If program code is entered or altered through the GUI pane R2, then, after a new intermediate prompt is generated from the updated code, the corresponding modification history of the intermediate prompt is displayed in the history-display pane R4. Because FIG. 7B shows the initial state, nothing is yet displayed in the history-display pane R4, but, for example, history information indicating that creation of the application has started may be shown. Each item of history information is managed by version information that indicates the order in which generation or modification processing of intermediate prompts has been performed. The system is designed so that the user can revert both the intermediate prompt and the program code to any desired version state and then update them anew from that state. The control unit 11 therefore accepts, for any item of history displayed in the pane R4, an instruction to revert—or “downgrade”—to the state immediately before or immediately after execution of the processing indicated by that history item. When such an item is specified and a downgrade instruction is received, the control unit 11 restores the intermediate prompt and the program code to the state that preceded (for example, just before an edit operation) or followed (for example, just after an edit operation) the processing indicated by the selected history item, and it also reverts the display contents of the application-design screen accordingly. In this way the user can return the intermediate prompt and program code to any desired version, permitting efficient execution of editing operations through iterative execution and reversal of edits. The layout of the application-design screen is not limited to that of FIG. 7B. For example, like the GUI pane R2, the prompt-wizard pane R3 may be configured so that selecting a menu item in the menu pane R1 causes the system to switch the display to the intermediate-prompt field I3 corresponding to that item. Alternatively, the prompt-wizard pane R3 may be divided into multiple panes, with each pane displaying the intermediate-prompt field I3 corresponding to a respective menu item.

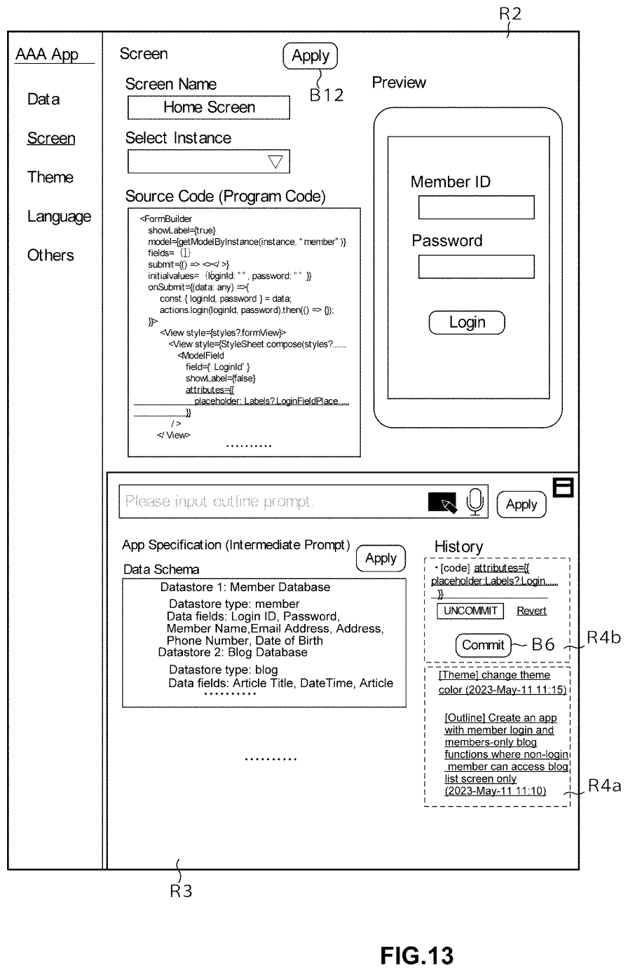

In the application-design screen configured as described above, when a user generates software (program code) by means of natural language through the prompt-wizard pane R3, the user either inputs an outline prompt in the outline prompt field I2 or inputs an intermediate prompt in the intermediate-prompt field I3 and then presses the Apply button B3 or B4. When the user instead generates software through the GUI pane R2, the user enters the setting information for each menu item through the GUI. When the user wishes to input program code directly, the code is entered via an input field provided in the GUI pane R2; as shown in FIG. 13, the GUI pane R2 includes such an input (display) field for program code. Moreover, when history information is displayed in the history-display pane R4, the user can revert both the intermediate prompt and the program code to any desired past version by instructing a downgrade for any selected history item.

On the screen shown in FIG. 7B, the control unit 11 of the information-processing apparatus 10 first determines whether an outline prompt has been entered via the outline prompt field I2 (S15). If an outline prompt is present (S15: YES), the flow proceeds to step S20. If no outline prompt has been entered (S15: NO), the control unit 11 checks whether an intermediate prompt has been entered via the intermediate-prompt field I3 (S16). When an intermediate prompt is detected (S16: YES), the flow advances to step S48. If the intermediate prompt is absent (S16: NO), the control unit 11 determines whether setting information has been entered through the GUI provided in the GUI pane R2 (S17). If such setting information is present (S17: YES), control passes to step S73. If the control unit 11 determines that no setting information has been entered through the GUI (S17: NO), it checks whether program code has been entered via the GUI pane R2 (S18). When it concludes that such code has been entered (S18: YES), processing advances to step S88. If, instead, it concludes that no code has been entered (S18: NO), the control unit 11 determines whether an instruction to perform a downgrade has been received (S19). When that instruction has been received (S19: YES), processing moves to step S102. When the control unit 11 determines that no downgrade instruction has been received (S19: NO), it returns to step S15.

When the control unit 11 determines that an outline prompt has been entered (S15: YES), it accepts the entered outline prompt and displays it in the outline prompt field I2 on the application-design screen (S20). The outline prompt may be accepted as text entered through the input unit 14, as an image when the image-input button B1 is pressed, or as voice input when the voice-input button B2 is pressed. The control unit 11 can also accept the outline prompt in various file or data formats, including text files, video files, PDF files, and binary files. Next, the control unit 11 checks whether the Apply button B3 has been pressed (S21). If the button has not been pressed (S21: NO), the process returns to step S20 and continues to accept outline-prompt input in the outline prompt field I2.

When the control unit 11 determines that the Apply button B3 has been pressed (S21: YES), it generates an intermediate prompt on the basis of the entered outline prompt (S22). Specifically, the control unit 11 inputs the outline prompt currently displayed in the outline prompt field I2 to the natural-language processing model M, and obtains from the model an intermediate prompt that describes, in natural language, a detailed specification of the application to be generated. The outline prompt may contain text data, image data, or both. The control unit 11 may submit the outline prompt to the model without modification, or it may prepend a message that guides the model's output—for example, “Please create a detailed specification for the following software.” If the natural-language processing model M is capable of accepting images and the outline prompt includes image data, the control unit 11 supplies the prompt—including the images—to the model. Instead of passing the images directly, the control unit 11 may, by optical character recognition (OCR), extract text from the images and submit that text to the model. The intermediate prompt returned by the model need not be limited to textual data; it may also include image data, whether still or animated. For example, the natural-language processing model M may be configured to output image files—such as still images or video—that were supplied as part of the outline prompt either unchanged or partially modified. The natural-language processing model M may also be configured to generate and output new image files on the basis of the outline prompt. By using such a natural-language processing model M, it becomes possible, for instance, to produce screen designs for the application directly from the content of the outline prompt.

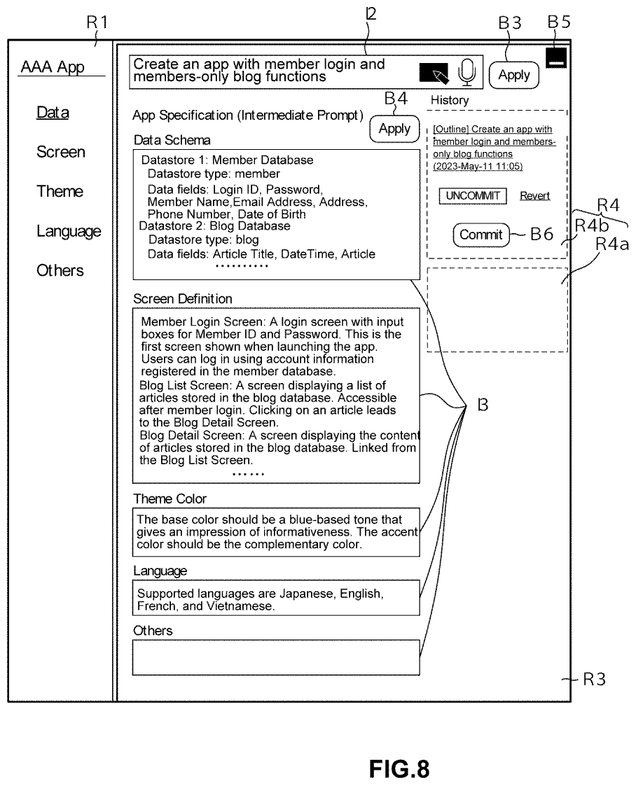

The control unit 11 displays the generated intermediate prompt in the intermediate-prompt field I3 (S23). The control unit 11 thereby shows, for example, the application-design screen illustrated in FIG. 8. The screen in FIG. 8 depicts a state in which the prompt-wizard pane R3 is enlarged, and the screen-switch button B5 within that screen has been changed so that it now accepts an instruction to switch to a screen where the GUI pane R2 and the prompt-wizard pane R3 are displayed side by side. In FIG. 8, the outline prompt field I2 contains the outline prompt “Please create an app that has a member-login function and a member-only blog function,” and each intermediate-prompt field I3 corresponding to the respective menu items shows the intermediate prompt generated from that outline prompt. When inputting the outline prompt to the natural-language processing model M, the control unit 11 instructs the model to output data for each setting item (menu item). For example, the control unit 11 appends to the outline prompt a message such as “Please create a detailed specification for the Data Schema” in order to control the output produced by the natural-language processing model M, and then submits the prompt to the model. In this manner, the control unit 11 can obtain, for each menu item, the intermediate prompt generated by the natural-language processing model M and display each obtained intermediate prompt in its corresponding intermediate-prompt field I3.

The control unit 11 may also divide the output data produced by the natural-language processing model M—obtained by inputting the outline prompt into the model—into portions corresponding to the respective setting items (menu items) and display each portion in its corresponding intermediate-prompt field I3. For example, the control unit 11 may search the output data from the natural-language processing model M for terms related to Data Schema (data structure), extract content related to Data Schema from the search results, and display the extracted content in the Data Schema intermediate-prompt field I3. In like manner, the control unit 11 may search the output data for terms related to Screen Definition, extract content related to Screen Definition, and display the extracted content in the Screen Definition intermediate-prompt field I3. It may further search the output data for terms related to Theme Color, extract content related to Theme Color, and display the extracted content in the Theme Color intermediate-prompt field I3. Likewise, it may search for terms related to Language, extract content related to Language, and display the extracted content in the Language intermediate-prompt field I3. The control unit 11 may display any remaining content that has not been extracted in the Others intermediate-prompt field I3. Even in such a configuration, the intermediate prompt generated from the outline prompt using the natural-language processing model M is displayed, for each menu item, in the intermediate-prompt field I3 corresponding to that menu item.

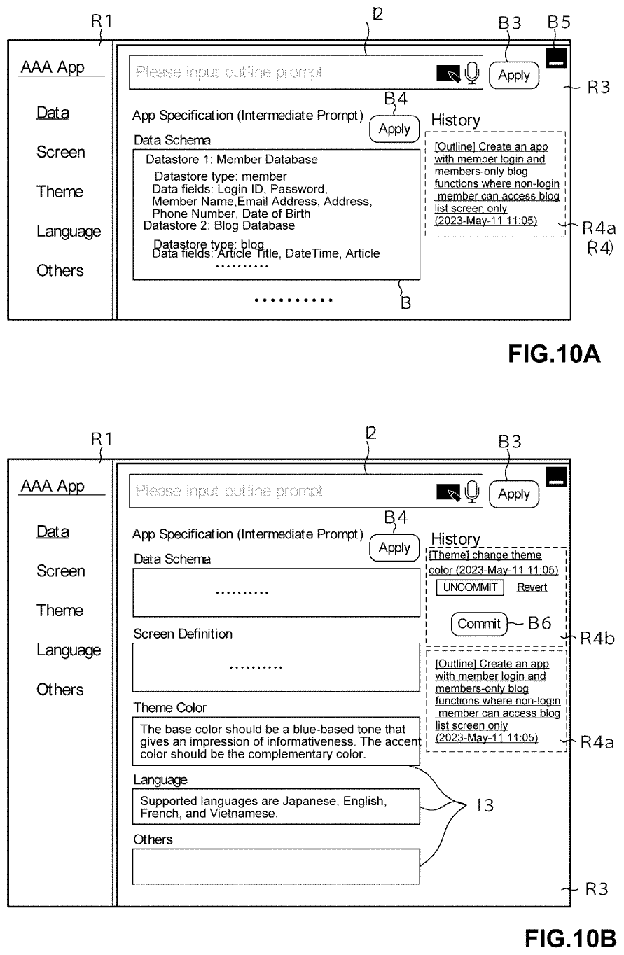

The control unit 11 generates history information that records the content of the generation processing by which the intermediate prompt was produced from the outline prompt (intermediate-prompt generation history information), appends version information (a version number) to that history information, stores it in the storage unit 12, and displays it in the history-display pane R4 of the application-design screen (S24). In the screen of FIG. 8, the history information shown includes the outline-prompt text itself and the date and time at which the intermediate prompt was generated from that outline prompt. The history-display pane R4 has an uncommitted area R4b, which shows history information where the intermediate prompt and program code under creation have not yet been finalized (hereinafter “uncommitted state”), and a committed area R4a, which shows history information after the intermediate prompt and program code have been finalized (hereinafter “committed state”). Here, because the newly generated intermediate prompt is still uncommitted, the control unit 11 displays its generation history in the uncommitted area R4b. The control unit 11 emphasizes uncommitted history information—by underlining it, as shown in FIG. 8—and also displays, in the uncommitted area R4b, a Revert button for cancelling the processing represented by the uncommitted history information (in this case, generation of the intermediate prompt from the outline prompt) and a Commit button B6 for finalizing the uncommitted intermediate prompt. When the Revert button is pressed, the control unit 11 restores the outline prompt field I2, the intermediate-prompt field I3, and the history-display pane R4 to the states they were in immediately before execution of the processing represented by the uncommitted history information, thereby returning the intermediate prompt and the program code under creation to that earlier state. The control unit 11 may, instead of reverting the outline prompt field I2 to its earlier content, leave the outline prompt entered during that processing displayed; in that case the user can revise the already displayed outline prompt without re-entering it. When the Commit button B6 is pressed and program code corresponding to the intermediate prompt currently shown in the intermediate-prompt field I3 has not yet been generated, the control unit 11 generates that program code and finalizes both the intermediate prompt and the program code. It then moves the history information corresponding to the committed intermediate prompt and program code to the committed area R4a and displays it there, as illustrated in FIG. 10A, while removing the emphasis highlighting. The control unit 11 may also input the outline-prompt content to the natural-language processing model M, generate a summary of that content, and use the summary as the intermediate-prompt generation history information. In the state shown in FIG. 8, where an intermediate prompt has been generated from the outline prompt and is displayed, the outline prompt field I2 remains editable; the user can inspect the intermediate prompt, edit the outline prompt as necessary, and press the Apply button B3 again.

In the state shown in FIG. 8, the control unit 11 determines whether it has accepted any edits to the outline prompt displayed in the outline prompt field I2 (S25). When it concludes that such edits have been accepted (S25: YES), processing returns to step S20, and steps S20 through S24 are executed again. Specifically, the control unit 11 displays the edited outline prompt in the outline prompt field I2 and, when the Apply button B3 is operated, it uses the natural-language processing model M to generate an intermediate prompt from the edited outline prompt, displays the generated intermediate prompt in the intermediate-prompt field I3, and shows the history information of the intermediate-prompt generation process in the uncommitted area R4b of the history-display pane R4. Here, because an intermediate prompt generated from the previous outline prompt is already visible in the intermediate-prompt field I3, at step S22, the control unit 11 may input both the edited outline prompt and the existing intermediate prompt to the natural-language processing model M so that the model produces a new intermediate prompt corresponding to the edited outline prompt. Alternatively, the control unit 11 may extract the differences between the outline prompt before and after editing and input those differences together with the existing intermediate prompt to the model, thereby obtaining the new intermediate prompt. In this approach, the content displayed in the intermediate-prompt field I3 is updated to the new intermediate prompt, and the uncommitted area R4b is refreshed with the history information associated with that updated prompt.

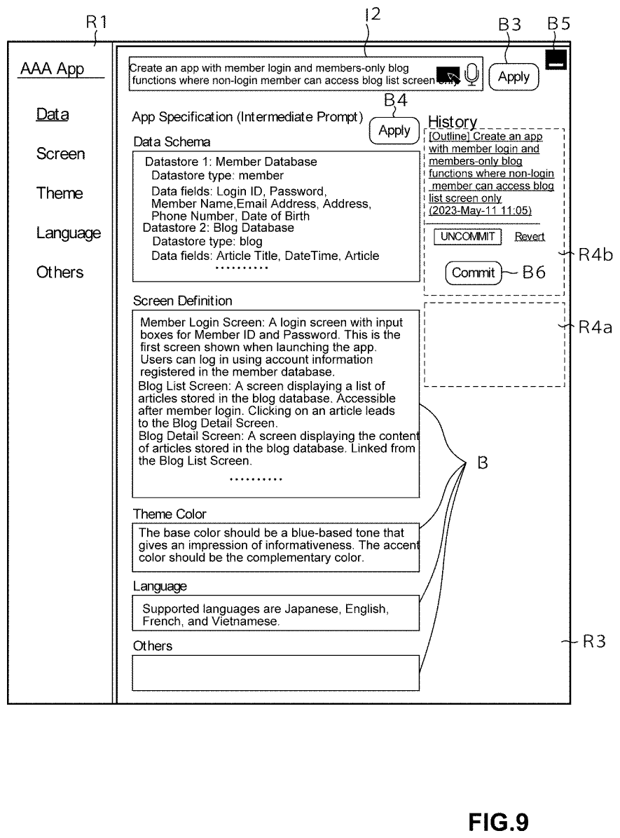

At this stage, the control unit 11 presents, on the display unit 15, the application-design screen exemplified in FIG. 9. In that screen, the outline prompt field I2 shows the edited outline prompt, the intermediate-prompt field I3 shows the intermediate prompt corresponding to the edited outline prompt, and the history-display pane R4 (uncommitted area R4b) highlights the history information for the processing in which the new intermediate prompt was generated. Although FIG. 9 underlines, in the Screen Definition intermediate-prompt field I3, the portions that were modified (added) through editing of the outline prompt, such highlighting is optional. The edited outline prompt shown in the outline prompt field I2 may likewise highlight the portions that have changed; doing so allows the user to grasp at a glance both the content added to the outline prompt and the content of the intermediate prompt that was altered by that edit. Even in the screen of FIG. 9, when the control unit 11 receives a cancel instruction for the uncommitted history information, it can restore the display contents of the outline prompt field I2, the intermediate-prompt field I3, and the history-display pane R4 to the state that existed before the processing indicated by that history information was executed.

In the screens shown in FIGS. 8 and 9, when the control unit 11 determines that no edit to the outline prompt has been accepted (S25: NO), it checks whether the Apply button B4 associated with the intermediate-prompt field I3 has been operated (S26). If the Apply button B4 is found to have been operated (S26: YES), the control unit 11 generates program code based on the intermediate prompt currently displayed in the intermediate-prompt field I3 (S27). To that end, the control unit 11 concatenates each menu item with the intermediate prompt displayed in its corresponding intermediate-prompt field I3, thereby forming a single piece of natural language text, and inputs the resulting text to the natural-language processing model M so as to obtain, from the model, program code for the application to be generated. The control unit 11 may supply the generated text (the intermediate prompt) to the natural-language processing model M without modification, or it may prepend information that specifies the desired program format—such as function names and the type information for arguments and return values—or a message that guides the model's output, for example, “Please create program code for the following application.” If the intermediate prompt includes image data in addition to text data, the control unit 11 likewise inputs the image data together with the text data to the natural-language processing model M and acquires program code from the model.

The control unit 11 executes a build process on the generated program code (S29). In the build process, the program code (source code) is analyzed to determine whether it contains any problems—such as errors or bugs—and, if no problem is found, the code is converted into an executable file; if a problem is detected, error information describing the issue is output. The control unit 11 determines whether the build process has succeeded (S30). When it concludes that the build process has failed (S30: NO)—for example, when error information is output as a result of the build—it issues an error message indicating the failure (S31) and then returns to step S25. The control unit 11 may present the error message at the top of the application-design screen, enabling the user to edit the outline prompt currently shown in the outline prompt field I2 on the basis of the reported error. If the control unit 11 subsequently receives such an edit to the outline prompt (S25: YES), processing from steps S20 through S24 is repeated.

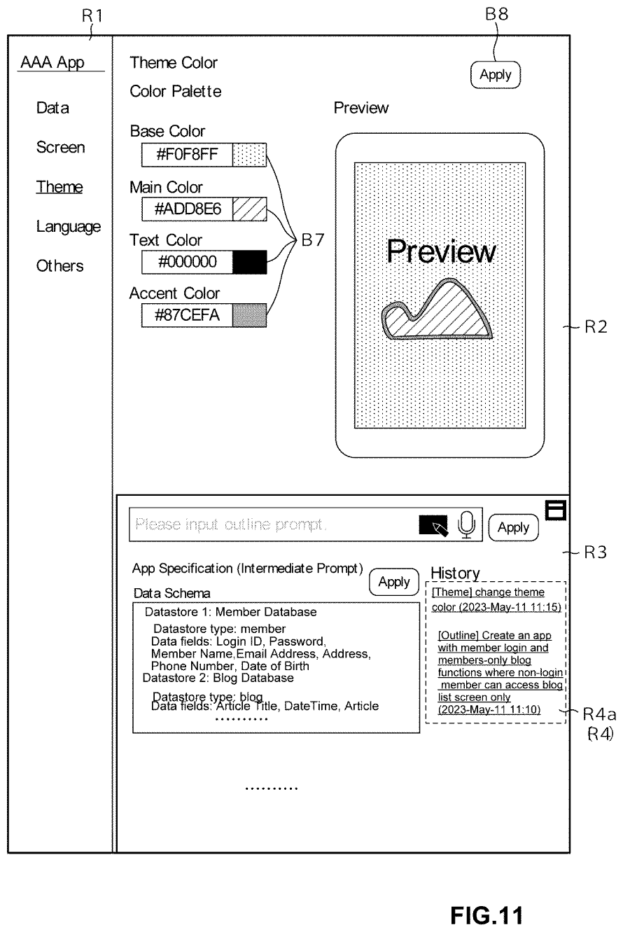

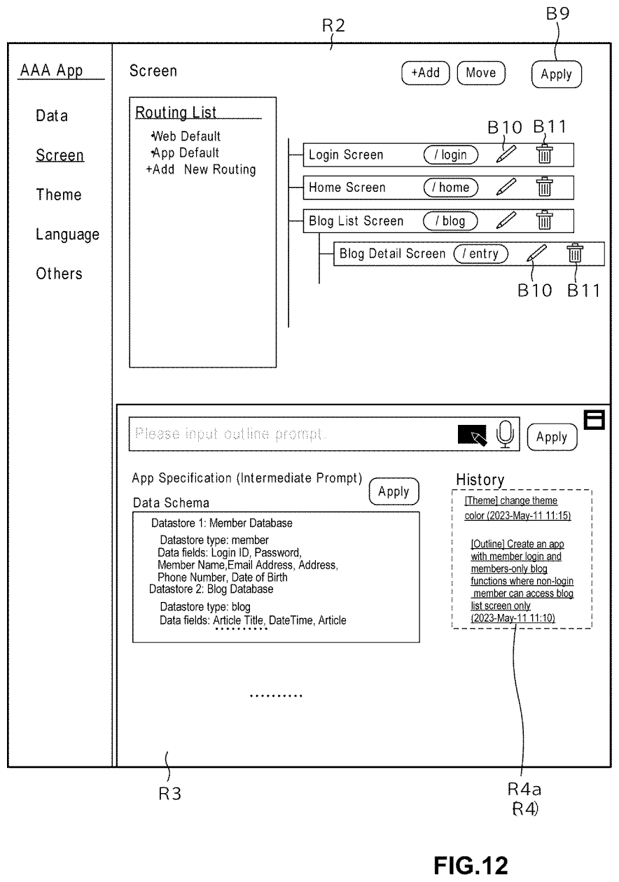

When the control unit 11 determines that the build process has succeeded (S30: YES), it displays, in the GUI pane R2 of the application-design screen, the setting contents (setting information) configured for each menu item on the basis of the generated program code (S32). The control unit 11 therefore presents, for example, the application-design screen whose GUI pane R2 is exemplified in FIG. 11 or FIG. 12. Through the menu pane R1, the user selects a menu item, and the control unit 11 shows, in the GUI pane R2, the setting contents for that selected item. FIG. 11 depicts an example of the GUI pane R2 when the menu item “Theme” has been selected, whereas FIG. 12 depicts an example when the menu item “Screen” has been selected.

Next, the control unit 11 performs a deployment process on the executable file generated from the program code during the build (S33). Deployment stores the executable in the execution environment (apparatus) where the application is to run and then starts the executable, thereby putting the application into operation. Once deployment has been carried out, the control unit 11 can display a screen preview of the application in the GUI pane R2, as shown in FIG. 11. Afterward, the control unit 11 creates history information by associating (i) the program code generated in step S27, (ii) the intermediate prompt used to generate that code, and (iii) the version information assigned to the intermediate prompt—for example, the version number assigned to the history information in step S24—and stores this history information in the storage unit 12 (S34) and the like. Linking the intermediate prompt and the program code to version information in this way allows the control unit 11 to restore the intermediate prompt and program code of a specified version when it later receives a downgrade instruction based on history information displayed in the history-display pane R4 (committed area R4a). When program code is generated for the application for the first time, the control unit 11 saves the code in a file whose name is predetermined or generated according to a predefined rule. If program code has already been generated for the application, the control unit 11 overwrites the existing file with the newly generated code. When saving intermediate prompts, the control unit 11 stores each prompt together with its corresponding menu item—Data Schema, Screen Definition, Theme Color, Language, or Others-according to the intermediate-prompt fields I3 in which those prompts are displayed.

In the screens illustrated in FIGS. 8 and 9, when the control unit 11 determines that the Apply button B4 associated with the intermediate-prompt field I3 has not been operated (S26: NO), it moves to step S35 and checks whether the Commit button B6 in the uncommitted area R4b has been operated (S35). If the Commit button B6 is found not to have been operated (S35: NO), the control unit 11 returns to the processing of step S25 and waits until an edit to the outline prompt is accepted, the Apply button B4 is operated, or the Commit button B6 is operated.

When, in the screens of FIGS. 8 and 9, the control unit 11 determines that the Commit button B6 has been operated (S35: YES), it checks whether program code has already been generated by operation of the Apply button B4, whether a build process has been executed for the generated program code, and whether that build was successful (S36). If the build process has not been executed (S36: NO), the control unit 11 performs the same processing as in steps S27-S34 (shown here as steps S37-S44). That is, whenever the Apply button B4 or the Commit button B6 is operated in the screens of FIGS. 8 and 9, the control unit 11 generates program code from the intermediate prompt currently displayed in the intermediate-prompt field I3, executes a build process for the program code, and then executes a deployment process. When generating program code, if program code has already been generated, the control unit 11 may input the existing program code to the natural-language processing model M together with the intermediate prompt displayed in the intermediate-prompt field I3 so as to obtain new program code. Alternatively, if program code has already been generated, the control unit 11 may extract a difference between the intermediate prompt used to generate the existing program code (a previous-version intermediate prompt) and the intermediate prompt currently displayed in the intermediate-prompt field I3 (a latest-version intermediate prompt), and input the extracted difference together with the existing program code (the previous-version program code) to the natural-language processing model M to generate the latest-version program code.

When the control unit 11 determines that a build process has been executed and that the executed build has succeeded (S36: YES), or after the processing of step S44, it finalizes the intermediate prompt currently displayed in the intermediate-prompt field I3 together with the program code generated from that intermediate prompt (S45). That is, the control unit 11 places, in a committed state, the intermediate prompt and the program code that were stored in the storage unit 12 in step S34 or step S44. Accordingly, when the Commit button B6 in the uncommitted area R4b is operated, the intermediate prompt and program code as of that moment are once finalized. The control unit 11 then updates the prompt-wizard pane R3 of the application-design screen currently being displayed (S46). For example, as shown in FIG. 10A, the control unit 11 clears the outline prompt field I2 into a blank, terminates the emphasis on the history information that had been displayed in the uncommitted area R4b, and moves that history information to the committed area R4a. In this case, the uncommitted area R4b is removed. In the state shown in FIG. 10A, it is possible to input a new outline prompt into the outline prompt field I2 and to edit the intermediate prompt in the intermediate-prompt field I3. The user visually checks the intermediate prompt displayed in the intermediate-prompt field I3 and, as necessary, inputs a new outline prompt or edits the intermediate prompt.

The control unit 11 determines whether an instruction to terminate the program-code generation processing has been accepted (S47). For example, the control unit 11 determines, via the input unit 14, whether an instruction to exit the design-support app AP has been accepted. If the control unit 11 determines that no termination instruction has been accepted (S47: NO), it returns to step S15 and, each time an outline prompt is entered or edited through the outline prompt field I2, executes the processing of steps S20 through S46. Accordingly, whenever an outline prompt is entered or edited, an intermediate prompt is generated on the basis of the entered or edited outline prompt, and program code is generated on the basis of the generated intermediate prompt. If the control unit 11 determines that the termination instruction has been accepted (S47: YES), it ends the series of processes.

When, in step S16, the control unit 11 determines that an intermediate prompt has been entered via the intermediate-prompt field I3 (S16: YES), it accepts the entered intermediate prompt and displays it in the intermediate-prompt field I3 on the application-design screen (S48). If an intermediate prompt is already displayed in the intermediate-prompt field I3, the control unit 11 accepts edits to that prompt and displays the edited intermediate prompt that has been accepted. The control unit 11 is configured to accept entry of the intermediate prompt via text input, voice input, or image input through the input unit 14. It is further configured to accept edits by receiving—through a mouse click at any desired position in the displayed intermediate prompt—an insertion position, and then accepting, via text input, voice input, or image input, content to be inserted at that position. For both input and editing of the intermediate prompt, the control unit 11 may also be configured to accept any type or format of data, including text files, image files, video files, PDF files, and binary files.

The control unit 11 appends a version number to editing-history information that indicates the input or edited content of the intermediate prompt, stores the information in the storage unit 12, and displays the editing-history information in the uncommitted area R4b of the application-design screen (S49). For example, it presents the screen shown in FIG. 10B, where the edited intermediate prompt is displayed in the Theme Color intermediate-prompt field I3, and the uncommitted area R4b of the history-display pane R4 shows both the editing-history information and the Commit button B6. The editing-history information includes the name of the edited menu item (Theme in FIG. 10B) and the date and time of the edit. In the same screen, the uncommitted area R4b can accept a cancel instruction for the uncommitted history information via a Revert button; when the Revert button is pressed, the control unit 11 returns the contents displayed in the intermediate-prompt field I3 and the history-display pane R4 to the state that existed immediately before execution of the processing indicated by the currently displayed history information. The control unit 11 may also input the intermediate-prompt content or edited content to the natural-language processing model M, generate a summary of that content, and use the summary as the editing-history information.

In the state shown in FIG. 10B—where an intermediate prompt is being entered or edited—the intermediate-prompt field I3 allows additions to and deletions from the intermediate prompt, and the user visually checks the intermediate prompt and edits it as necessary. The control unit 11 determines whether it has accepted an edit to the intermediate prompt (S50) and, when it concludes that an edit has been accepted (S50: YES), returns to step S48 and repeats the processing of steps S48 through S50. Accordingly, each time the intermediate prompt is edited, the control unit 11 updates the display content of the intermediate-prompt field I3 to the edited intermediate prompt and updates the display content of the uncommitted area R4b to history information regarding the updated intermediate prompt.

In the screen shown in FIG. 10B, when the control unit 11 determines that no edit to the intermediate prompt has been accepted (S50: NO), it checks whether the Apply button B4 associated with the intermediate-prompt field I3 has been operated (S51). If the Apply button B4 has been operated (S51: YES), the control unit 11 performs the same processing as in steps S27-S34 (here labeled steps S52-S59). Specifically, when the Apply button B4 is pressed in the screen of FIG. 10B, the control unit 11 generates program code from the intermediate prompt currently displayed in the intermediate-prompt field I3 and then performs a build process for the program code followed by a deployment process. In step S52, if program code has already been generated, the control unit 11 may input the existing program code to the natural-language processing model M together with the intermediate prompt displayed in the intermediate-prompt field I3, thereby obtaining new program code. Alternatively, the control unit 11 may extract a difference between the intermediate prompt before editing and the intermediate prompt after editing, input that difference together with the existing program code to the natural-language processing model M, and thus obtain the latest version of the program code. In step S59, the control unit 11 generates history information by associating (i) the program code generated in step S52, (ii) the edited intermediate prompt that was entered in step S48, and (iii) the version information assigned to that intermediate prompt, and stores the history information in the storage unit 12 for example.

When the control unit 11 determines that the Apply button B4, which is provided in association with the intermediate-prompt field I3 in the screen shown in FIG. 10B, has not been operated (S51: NO), it proceeds to step S60 and determines whether the Commit button B6 in the uncommitted area R4b on the screen has been operated (S60). If the Commit button B6 is determined not to have been operated (S60: NO), the control unit 11 returns to the processing of step S50 and waits until an edit to the intermediate prompt is accepted, the Apply button B4 is operated, or the Commit button B6 is operated.

When, in the screen of FIG. 10B, the control unit 11 determines that the Commit button B6 has been operated (S60: YES), it checks whether program code has already been generated by operation of the Apply button B4, whether a build process has been executed for the generated program code, and whether the executed build has succeeded (S61). If the control unit 11 concludes that the build process has not been executed (S61: NO), it performs the same processing as in steps S52 to S59 (here designated as steps S62 to S69). That is, whenever either the Apply button B4 or the Commit button B6 is operated in the screen of FIG. 10B, the control unit 11 generates program code from the intermediate prompt currently displayed in the intermediate-prompt field I3, executes a build process for the program code, and then performs a deployment process for the program code.

When the control unit 11 determines that a build process has been executed and that the executed build has succeeded (S61: YES), or after the processing of step S69, it finalizes the intermediate prompt currently displayed in the intermediate-prompt field I3 together with the program code generated from that intermediate prompt (S70). Accordingly, when the Commit button B6 in the uncommitted area R4b is operated, the intermediate prompt and program code at that time become committed. The control unit 11 then updates the prompt-wizard pane R3 of the application-design screen currently being displayed (S71). Step S71 is the same processing as step S46, whereby the prompt-wizard pane R3 is updated to the state shown in FIGS. 11 and 12. Specifically, the control unit 11 removes the emphasis from the history information displayed in the uncommitted area R4b, moves that information to the committed area R4a, and deletes the uncommitted area R4b. The control unit 11 determines whether an instruction to end the program-code generation processing has been accepted (S72) and, if it determines that no such instruction has been accepted (S72: NO), returns to step S15 and, each time an intermediate prompt is entered or edited through the intermediate-prompt field I3, executes the processing of steps S48 through S71. Thus, each time an intermediate prompt is entered or edited, program code is generated on the basis of the entered or edited intermediate prompt. If the control unit 11 determines that an end instruction has been accepted (S72: YES), it terminates the series of processes.

When the control unit 11 determines in step S17 that setting information has been entered via the GUI provided in the GUI pane R2 (S17: YES), the control unit 11 accepts the entered setting information and displays it in the GUI pane R2 on the application-design screen (S73). If setting information is already displayed in the GUI pane R2, the control unit 11 accepts edits to the displayed setting information and shows the edited setting information. The GUI pane R2 displays the setting information for the menu item selected through the menu pane R1. FIG. 11 shows the GUI pane R2 when the setting information for the menu item “Theme” is displayed, and the application's theme colors-base color (background color), main color, text color, and accent color-are shown. In the example of FIG. 11, the control unit 11 displays, as the setting for each color, the color code assigned to the set color, a color palette B7 showing the color, and a screen preview that uses the color, in the GUI pane R2. The color palette B7 is configured to accept changes to the setting content of each color. For example, when any color palette B7 is operated (e.g., clicked with a mouse), the control unit 11 displays a list of selectable colors, and, when a color is selected, updates the setting content—the set color for that color—to the selected color. When the setting of any color is changed, the control unit 11 displays the color code of the changed color, the color palette B7, and a screen preview that uses the changed color. An Apply button B8 is provided in the GUI pane R2 on the screen of FIG. 11 for instructing that content changed via the color palette B7 be applied (reflected). After the user changes the setting of any color via the color palette B7 on the screen of FIG. 11, the user operates the Apply button B8 to update (apply) the changed content.

FIGS. 12 and 13 show the GUI pane R2 when the setting information for the menu item “Screen” is displayed; the pane presents settings for the display screens of the application. In the GUI pane R2 of FIG. 12, a screen-transition diagram (routing) is shown, and for each screen the screen name and the ID assigned to that screen are displayed. The GUI pane R2 of FIG. 12 further includes, for each screen, an edit button B10 that instructs execution of an editing process for the corresponding screen and a delete button B11 that instructs deletion of the corresponding screen. In addition, an Apply button B9 is provided in the GUI pane R2 of FIG. 12; when any delete button B11 is operated, the Apply button B9 is used to instruct application (reflection) of the deletion of the screen corresponding to the operated delete button B11. After operating one of the delete buttons B11 in the screen of FIG. 12, the user operates the Apply button B9 to update (apply) the operation.

When any edit button B10 in the GUI pane R2 of FIG. 12 is operated, the control unit 11 of the information-processing apparatus 10 displays, as shown in FIG. 13, the setting information for the screen corresponding to the operated edit button B10. FIG. 13 illustrates an example in which the edit button B10 corresponding to “Home Screen” in the GUI pane R2 of FIG. 12 has been operated. The GUI pane R2 (preview pane) of FIG. 13 displays the screen name, source code (program code) for the screen, and a preview of the screen. The GUI pane R2 of FIG. 13 is configured to accept editing (modification) of the displayed program code, and when the control unit 11 accepts an edit of the program code, it displays the edited content (input content) in the GUI pane R2. In FIG. 13 the control unit 11 underlines the edited content to highlight it. An Apply button B12 is provided in the GUI pane R2 of FIG. 13 to instruct application (reflection) of the edits to the program code. After the user edits the program code in the screen of FIG. 13, the user operates the Apply button B12 to update (apply) the edited content.

FIGS. 11-13 illustrate a state in which program code is edited via the GUI pane R2 for the “Theme” and “Screen” menu items, and program code can likewise be edited via the GUI pane R2 for the “Data,” “Language,” and “Others” menu items. For example, for the “Data” menu item, the GUI pane R2 displays information on the configured database such as the names of data fields, the type of data stored in each field, the number of digits, and the data size, which are configured so that each item can be edited. Similarly, for the “Language” menu item, the GUI pane R2 displays, as information on the selected languages, the correspondences (translations) between the respective languages, which are arranged so that each item can be edited.

In the screens shown in FIGS. 11 and 12, the control unit 11 determines whether the Apply buttons B8 and B9 provided in the GUI pane R2 have been operated (S74), and, if they are judged not to have been operated (S74: NO), it returns to the processing of step S73 and continues to accept the entry or editing of setting information via the GUI. If the control unit 11 judges that the Apply buttons B8 and B9 in the GUI pane R2 have been operated (S74: YES), it generates program code on the basis of the setting for each menu item that are displayed in the GUI pane R2 at that time (S75). For example, on the basis of the setting for each menu item currently displayed in the GUI pane R2—namely, the setting after entry or editing via the GUI pane R2—the control unit 11 updates the program code that has been generated up to that time and generates new program code. Specifically, the control unit 11 rewrites various setting values contained in the existing program code in accordance with the setting of the respective menu items. The control unit 11 may instead generate new program code by inputting the edited setting together with the program code generated up to that time into the natural-language processing model M. Furthermore, the control unit 11 may input the edited setting together with the intermediate prompt currently displayed in the intermediate-prompt field I3 into the natural-language processing model M to generate an intermediate prompt corresponding to the edited setting contents, and may then input, for each menu item, the generated intermediate prompt into the natural-language processing model M to generate new program code. At that time, the control unit 11 may generate new program code by inputting the generated intermediate prompt together with the program code generated up to that time into the natural-language processing model M, or may extract a difference (changed content) between the intermediate prompt before and after generation, input the extracted difference together with the existing program code into the natural-language processing model M, and thereby generate new program code.

Thereafter, the control unit 11 performs the same processing as in steps S29 to S31 (depicted as steps S77 to S79). After completing the processing of step S79, the control unit 11 returns to the processing of step S73. When the control unit 11 determines that the build process has succeeded (S78: YES), it generates, from the program code generated in step S75 (the updated program code), an intermediate prompt corresponding to that program code and updates the intermediate prompt displayed in the intermediate-prompt field I3 (S80). For example, the control unit 11 extracts a difference (changed content) between the program code before the update and the program code after the update, inputs the extracted difference together with the intermediate prompt corresponding to the program code before the update into the natural-language processing model M, and thereby generates an intermediate prompt corresponding to the program code after the update. The control unit 11 then displays, in the intermediate-prompt field I3, the generated intermediate prompt corresponding to the updated program code. Note that generating the intermediate prompt corresponding to the updated program code is not limited to using the natural-language processing model M. For example, the control unit 11 may register, in advance, a partial intermediate prompt corresponding to each change in the program code, identify the partial intermediate prompt that corresponds to the difference between the program code before the update and the program code after the update, and generate the intermediate prompt corresponding to the program code after the update by adding the identified partial intermediate prompt to the intermediate prompt corresponding to the program code before the update.

The control unit 11 appends a version number to update-history information that indicates the result of generation (the update) of the intermediate prompt corresponding to the updated program code, stores the update-history information in the storage unit 12, and displays the update-history information in the uncommitted area R4b of the application-design screen (S81). The control unit 11 then performs the same processing as in steps S33-S34 (depicted as steps S82-S83). In step S83, the control unit 11 generates history information by associating the program code generated in step S75, the updated intermediate prompt generated in step S80, and the version number assigned to that intermediate prompt, and stores the history information in the storage unit 12. Next, the control unit 11 determines whether the Commit button B6 in the uncommitted area R4b has been operated (S84). If the Commit button B6 has not been operated (S84: NO), the control unit 11 returns to the processing of step S73 and, each time setting information is edited via the GUI and the Apply button B8 or B9 is operated, executes processing that generates (updates) program code from the setting information displayed in the GUI pane R2, along with a build process and a deployment process for the program code. The control unit 11 also performs generation processing of an intermediate prompt corresponding to the updated program code and displays the update-history information for the generated intermediate prompt in the uncommitted area R4b.

When the control unit 11 determines that the Commit button B6 has been operated (S84: YES), the control unit 11 finalizes the intermediate prompt currently displayed in the intermediate-prompt field I3 and the program code corresponding to that intermediate prompt (S85). The control unit 11 then updates the prompt-wizard pane R3 of the application-design screen being displayed (S86). Step S86 performs the same processing as step S46. The control unit 11 determines whether an instruction to terminate the program-code-generation processing has been accepted (S87) and, when it determines that no such instruction has been accepted (S87: NO), it returns to the processing of step S15 and, each time setting information is entered or edited via the GUI, executes the processing of steps S73 to S86. Accordingly, each time setting information is entered or changed via the GUI, program code is generated or updated on the basis of the entered or changed setting information for each menu item, and an intermediate prompt is generated on the basis of the generated or updated program code. When the control unit 11 determines that a termination instruction has been accepted (S87: YES), it ends the series of processes.

When, in step S18, the control unit 11 determines that program code has been entered through the GUI pane R2 (S18: YES), it accepts the entered program code and displays it in the GUI pane R2 on the application-design screen (S88). If program code is already displayed in the GUI pane R2, the control unit 11 accepts edits to that code and displays the edited program code. For example, as shown in FIG. 13, the control unit 11 updates the program code shown in the GUI pane R2 to the edited program code. In the screen of FIG. 13, the control unit 11 determines whether the Apply button B12 provided in the GUI pane R2 has been operated (S89); if it determines that the button has not been operated (S89: NO), it returns to step S88 and continues to accept entry or editing of program code via the GUI pane R2. If the control unit 11 determines that the Apply button B12 has been operated (S89: YES), it performs the same processing as in steps S77 to S81 (here designated as steps S90 to S94). In step S90, the control unit 11 executes a build process for the program code that was entered or edited through the GUI pane R2 in step S88 (the updated program code). In step S93, on the basis of the updated program code, the control unit 11 generates an intermediate prompt corresponding to the updated program code. Here, the control unit 11 treats the edit content of the program code as the difference between the program code before and after the update and, by inputting that difference together with the intermediate prompt corresponding to the program code before the update into the natural-language processing model M, generates the intermediate prompt corresponding to the updated program code. If a partial intermediate prompt corresponding to the change content of the program code has been registered in advance, the control unit 11 may identify the partial intermediate prompt corresponding to the difference between the program code before and after the update and may generate the intermediate prompt corresponding to the updated program code by adding the identified partial intermediate prompt to the intermediate prompt corresponding to the program code before the update. In step S94, the control unit 11 appends a version number to update-history information regarding the intermediate prompt corresponding to the updated program code and stores the update-history information in the storage unit 12 while displaying it in the uncommitted area R4b.

Next, on the basis of the updated program code, the control unit 11 updates the display content (setting information) of each menu item in the GUI pane R2 (S95). Consequently, the display content of each menu item in the GUI pane R2 is changed so as to reflect the edit content of the program code that was entered or edited through the GUI pane R2. The control unit 11 then performs the same processing as in steps S82 to S86 (here designated steps S96 to S100). In step S97, the control unit 11 generates history information by associating the updated program code accepted in step S88, the intermediate prompt corresponding to the updated program code generated in step S93, and the version number assigned to that intermediate prompt, and stores the history information in the storage unit 12. Here again, for example, the control unit 11 may input the program code before and after editing to the natural-language processing model M, generate a summary of the edit content for the program code, and use the summary as editing-history information for the program code. If the control unit 11 determines that the Commit button B6 has not been operated (S98: NO), it returns to step S88 and, each time an edit to the program code is accepted and the Apply button B12 is operated, executes a build process and a deployment process for the entered or changed program code. The control unit 11 also generates an intermediate prompt corresponding to the updated program code and displays the update-history information for the generated intermediate prompt in the uncommitted area R4b.

The control unit 11 determines whether an instruction to terminate the program-code-generation processing has been accepted (S101), and, when it determines that no termination instruction has been accepted (S101: NO), returns to step S15 and, each time program code is entered or edited via the GUI pane R2, executes the processing of steps S88-S100. Accordingly, each time program code is entered or edited, an intermediate prompt is generated on the basis of the entered or edited program code. When the control unit 11 determines that a termination instruction has been accepted (S101: YES), it ends the series of processes.

When, in step S19, the control unit 11 determines that an instruction to execute a downgrade has been accepted (S19: YES), it accepts the version information (version number) to which the downgrade is to be performed (S102). For example, on the basis of the history information displayed in the history-display pane R4 (committed area R4a) of the prompt-wizard pane R3, the control unit 11 is configured to accept a downgrade instruction and to identify the version information of the history item for which downgrade was instructed. The control unit 11 reads, from the storage unit 12, the intermediate prompt and program code associated with the identified version information (S103), executes a build process for the program code (S104) that are read, and generates an executable file. Next, on the basis of the intermediate prompt, the control unit 11 updates the prompt-wizard pane R3 (S106). Here, the control unit 11 displays the read intermediate prompt in the intermediate-prompt field I3 of the prompt-wizard pane R3 and displays, in the committed area R4a, the history information up to the version for which downgrade was instructed.

Subsequently, on the basis of the program code read in step S103, the control unit 11 updates the GUI pane R2 (S107). In this step, the control unit 11 displays, in the GUI pane R2, the setting information and the program code for each menu item in accordance with the read program code. Thereafter, the control unit 11 performs a deployment process for the executable file generated by the build process of step S104 (S108). Consequently, an application-design screen based on the intermediate prompt and program code corresponding to the version specified by the downgrade instruction is displayed. The control unit 11 then proceeds to step S101, and, when it determines that no termination instruction has been accepted (S101: NO), returns to step S15 and, each time a downgrade instruction is accepted, executes the processing of steps S102-S108. When the control unit 11 determines that a termination instruction has been accepted (S101: YES), it ends the series of processes.

Through the processing described above, in the present embodiment, software (program code) can be generated on the basis of prompts—outline prompts and intermediate prompts—entered in natural language and/or images. Prompts can also be edited in natural language and/or images, and program code can be modified by editing the prompts. Prompt input and editing may be performed by text input, image input, voice input, and the like. Accordingly, even a user who lacks specialized knowledge such as software-design or development skills can design and develop arbitrary software. In this embodiment, an outline prompt containing an application outline is accepted; an intermediate prompt indicating detailed specification content of the application is generated from the outline prompt; and program code is generated from the intermediate prompt. Although it would be possible to generate program code directly from the outline prompt, such a method may produce program code not intended by the user, leading to an increased number of rework operations such as code corrections. By contrast, in the present embodiment, generating program code from an intermediate prompt that has been produced from the outline prompt enables the intended program code to be obtained with fewer corrections. Moreover, because the intermediate prompt used for program-code generation serves as a detailed specification documentation for the application, a separate task of preparing a software specification apart from code generation can be reduced. Although the foregoing description explains processing that generates program code based on prompts, the target to be generated is not limited to program code for implementing an application; it may instead be a configuration file used in the application, for example.

In the present embodiment, the processing of generating an intermediate prompt from an outline prompt using the natural-language processing model M, and the processing of generating program code from an intermediate prompt using the model M, are not limited to being executed locally by the information-processing apparatus 10. For example, those processes may instead be executed on a server that provides the natural-language processing model M. The information-processing apparatus 10 can be configured to transmit the outline prompt, entered via the prompt-wizard pane R3, to the server and to receive from the server an intermediate prompt generated from the outline prompt. Likewise, the apparatus 10 can be configured to transmit the intermediate prompt displayed in the prompt-wizard pane R3 to the server and to receive from the server program code generated from that intermediate prompt. The same applies to (i) generating new program code from setting information of program code that has been changed via the GUI, (ii) generating an intermediate prompt corresponding to the changed setting information, and (iii) generating an intermediate prompt corresponding to updated program code; none of these processes need be executed locally by the apparatus 10.

### Embodiment 2

Here, an information-processing apparatus is described that attempts to correct error locations using the natural-language processing model M, when a build process fails In the first embodiment above. Because the information-processing apparatus of the present embodiment has the same hardware configuration as the apparatus 10 in FIG. 1, explanation thereof will not be repeated.

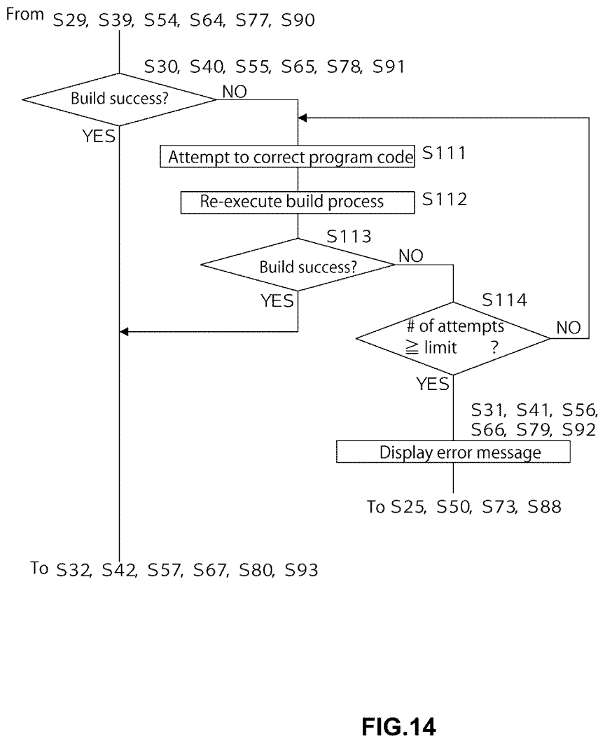

FIG. 14 is a flowchart illustrating an example procedure for program-code generation in Embodiment 2. The steps S111-S114 shown in FIG. 14 are added, respectively, between steps S30-S31, S40-S41, S55-S56, S65-S66, S78-S79, and S91-S92 in the procedure of FIGS. 2-6. Steps identical to those in FIGS. 2-6 are not described again, and steps other than S30-S31, S40-S41, S55-S56, S65-S66, S78-S79, and S91-S92 are omitted from FIG. 14.

When the control unit 11 of the information-processing apparatus 10 determines, at any of steps S30, S40, S55, S65, S78, or S91, that the build process has failed (NO), it attempts to correct the program code (S111). Specifically, the control unit 11 may input, into the natural-language processing model M, the program code that was subjected to the build process and error information output by the build process (indicating problems in the program code), thereby obtaining corrected program code from the model M. The control unit 11 then executes the build process again on the corrected program code (S112). It judges whether this subsequent build has succeeded (S113). If the build has failed (S113: NO), the control unit 11 determines whether the number of correction attempts has reached a predetermined limit (e.g., five or ten attempts) (S114). If the number of attempts is below the limit (S114: NO), control returns to step S111 and steps S111-S114 are repeated. In step S111 on subsequent iterations, the control unit 11 may input the most recently generated corrected program code together with the error information produced by its build process into the natural-language processing model M to obtain further corrected code.

When the build process succeeds (S113: YES), the control unit 11 proceeds to one of steps S32, S42, S57, S67, S80, or S93 and executes the subsequent processing beginning with that step for the successfully built program code. Conversely, when the number of correction attempts has reached the predetermined limit (S114: YES), the control unit 11 proceeds to one of steps S31, S41, S56, S66, S79, or S92 and outputs an error message indicating that the build failed and that the program code could not be corrected. Control then returns to steps S25, S50, S73, or S88, depending on context.

Through the processing described above, in the present embodiment, if the program code generated from an intermediate prompt or the like contains a problem and the build process fails, the natural-language processing model M can be used to attempt automatic correction of the code. The control unit 11 may perform multiple correction attempts up to the predetermined limit. If, even after the predetermined number of attempts, the problem remains and the build still fails, an error message is output, and the user can regenerate program code by editing the outline prompt, editing the intermediate prompt, editing setting information via the GUI, or editing the program code itself.

Except for the processing that attempts to correct program code upon build failure using the natural-language processing model M, the present embodiment performs the same processing as Embodiment 1 and achieves the same effects.

Moreover, because the present embodiment tries to correct program code using the natural-language processing model M, such problems (errors, bugs, and the like) that can be resolved by the model M can be corrected automatically, thereby reducing the operational burden on the user. The variations described with respect to Embodiment 1 may be applied mutatis mutandis to the present embodiment as well.

### Embodiment 3

An information-processing apparatus configured to accept outline prompts interactively will be described. Because the apparatus of the present embodiment has the same hardware configuration as the apparatus 10 in FIG. 1, the explanation on that configuration is not repeated here.

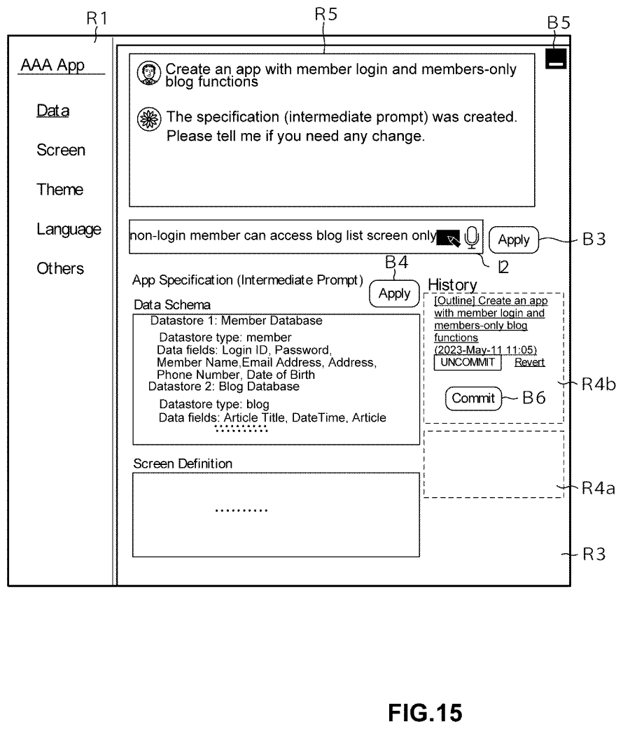

FIG. 15 shows a variation of application-design screen. In addition to the elements in FIGS. 8-10B, this screen includes, above the outline prompt field I2 in the prompt-wizard pane R3, an outline-prompt history pane R5 that displays the entry history of outline prompts. When an outline prompt is entered into the field I2 and the Apply button B3 is pressed, an intermediate prompt is generated from the outline prompt, displayed in the intermediate-prompt field I3, and its generation history is shown in the uncommitted area R4b of the history-display pane R4—exactly as in Embodiment 1. In addition, the entered outline prompt is moved to the outline-prompt history pane R5 and removed from the field I2. When an outline prompt appears in the history pane R5, dialogue information prompting the user for additional outline-prompt input is displayed in the same pane, and the user enters a new outline prompt in response.

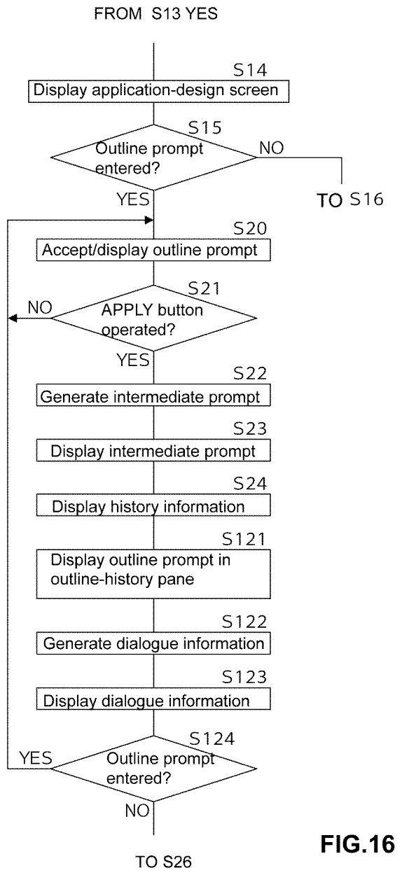

FIG. 16 is a flowchart of an example program-code-generation procedure for Embodiment 3. Relative to FIGS. 2-6, steps S121-S124 replace step S25. Steps identical to those in FIGS. 2-6 are not described again, and steps other than S14-S15 and S20-S24 are omitted from FIG. 16.

In this embodiment, when the control unit 11 determines, in step S21, that the Apply button B3 has been pressed (S21: YES), it executes steps S22-S24, displaying the application-design screen as show in FIG. 8. The control unit 11 then moves the outline prompt entered in the outline prompt field I2 into the outline-prompt history pane R5 (S121) and deletes it from the outline prompt field I2.

Next, based on the outline prompt moved to the history pane R5, the control unit 11 generates dialogue information that prompts the user for the next action-such as supplying another outline prompt (S122). For example, the control unit 11 may input the outline prompt, or the outline prompt together with the intermediate prompt displayed in the field I3, into the natural-language processing model M and obtain, from the model, dialogue information written in natural language. The outline prompt (and the intermediate prompt, if any) may be supplied to the natural-language processing model without modification or may be prefaced with a directive such as “Generate a message telling the user what to do next.” The dialogue information may include questions about the outline prompt or instructions to operate buttons such as Apply B4 or Commit B6. The generated dialogue information is displayed in the outline-prompt history pane R5 (S123). In FIG. 15 the message “The specification (intermediate prompt) has been generated; let me know if changes are needed” appears as such dialogue information. If the information-processing apparatus 10 includes a speaker, the dialogue information may also be output as a voice.

The user reviews the dialogue information in the history pane R5 and, as necessary, enters a new outline prompt. The control unit 11 determines whether a new outline prompt has been entered via the field I2 (S124) and, when one is entered (S124: YES), returns to step S20, after which the processing of steps S20-S24 and S121-S123 is repeated for the new outline prompt. If no new outline prompt is entered (S124: NO), control proceeds to step S26 and the subsequent processing.

Because the user can enter outline prompts in the form of replies to dialogue information displayed in the history pane R5, the input burden is reduced. Although, in the present embodiment, dialogue information generated by the natural-language processing model M is shown in response to each user-entered outline prompt, the system could instead display, before any outline prompt is entered, helpful messages or hints in the history pane R5; this allows users who are uncertain what to write to follow those prompts.

The dialogue information shown in the outline-prompt history pane R5 need not be generated exclusively by the natural-language processing model M. For example, the system may store dialogue information associated with keywords and provide, as dialogue, the entry corresponding to any keyword detected in the user's outline prompt.

Except for displaying, in the history pane R5, each outline prompt together with dialogue information generated from it, the present embodiment performs the same processing as Embodiment 1 and achieves the same effects. Because outline prompts can be entered by answering dialogue information, the user's burden is reduced, and even users unfamiliar with prompt engineering can supply appropriate outline prompts—enabling higher-quality intermediate prompts and program code. The configuration of this embodiment can also be applied to the information-processing apparatus 10 of Embodiment 2 and yields the same advantages; the variations described for Embodiments 1 and 2 likewise can be applied here.

The matters described in the embodiments above can be freely combined in any practicable manner. All combinations of the independent and dependent claims in the appended claims are intended to be encompassed regardless of citation format. Although multiple-dependent claims are used, the invention is not limited thereto; multiple-multiple-dependent claims may also be employed.

The disclosed embodiments are illustrative and not restrictive in every respect. The scope of the invention is defined by the appended claims, and all modifications within the meaning and scope of the claims and their equivalents are intended to be included.

### EXPLANATION OF REFERENCE SIGNS

10 . . . information-processing apparatus
11 . . . control unit
12 . . . storage unit
13 . . . communication unit
14 . . . input unit
15 . . . display unit
M . . . natural-language processing model

1. A program that causes a computer to execute processing comprising:
receiving an outline prompt indicating an outline regarding program code to be generated;
inputting the received outline prompt into a natural-language processing model to obtain a detailed prompt indicating detailed specification regarding program code; and
inputting the obtained prompt into the natural-language processing model to obtain the program code.

2. The program according to claim 1, wherein the processing further comprises:
outputting the obtained detailed prompt to a preview pane;
receiving an edit to the detailed prompt displayed in the preview pane; and
inputting the edited detailed prompt into the natural-language processing model to obtain the program code.

3. The program according to claim 2, wherein the processing further comprises:
displaying edit history information regarding the edit received for the detailed prompt.

4. The program according to claim 3, further comprising:
reverting, based on the edit history information, in response to an instruction to revert the detailed prompt and the program code to a state before or after the edit performed on the detailed prompt, the detailed prompt and the program code to a state before or after the edit.

5. The program according to any one of claims 2 to 4, wherein the processing further comprises:
inputting the extracted difference together with the program code corresponding to the detailed prompt before the edit into the natural-language processing model to obtain program code corresponding to the detailed prompt after the edit.

6. The program according to any one of claims 2 to 4, wherein the processing further comprises:
extracting differences between the detailed prompt before the edit and the detailed prompt after the edit, and
inputting the extracted difference together with the program code corresponding to the detailed prompt before the edit into the natural-language processing model to obtain program code corresponding to the detailed prompt after the edit.

7. The program according to any one of claims 1 to 4, wherein the processing further comprises outputting the program code to a preview pane and receiving an edit to the program code displayed in the preview pane.

8. The program according to claim 7, wherein the processing further comprises:
generating, based on the edited program code, a detailed prompt corresponding to the edited program code.

9. The program according to any one of claims 1 to 4, wherein the processing further comprises:
displaying a screen having a graphical user interface for generating the program code;
receiving, via the graphical user interface, setting information regarding the program code; and
generating the program code based on the received setting information.

10. The program according to claim 9, wherein the processing further comprises:
generating, based on the program code generated from the setting information, a detailed prompt corresponding to the program code.

11. The program according to any one of claims 1 to 4, wherein the processing further comprises:
receiving, via an input field that receives the outline prompt, an instruction to execute a process by the computer.

12. A program that causes a computer to execute processing comprising:
obtaining a detailed prompt indicating detailed specification regarding program code to be generated;
displaying the obtained detailed prompt to a preview pane;
receiving an edit to the detailed prompt displayed in the preview pane; inputting the edited detailed prompt into a natural-language processing model to obtain program code corresponding to the edited detailed prompt; and
storing edit history information associating the edited detailed prompt with the obtained program code.

13. An information-processing method executed by a computer, the method comprising:
receiving an outline prompt indicating an outline regarding program code to be generated;
inputting the received outline prompt into a natural-language processing model to obtain a detailed prompt indicating detailed specification content regarding the program code; and
inputting the obtained detailed prompt into the natural-language processing model to obtain the program code.

14. An information-processing apparatus comprising a control unit, the control unit being configured to:
receive an outline prompt indicating an outline regarding program code to be generated;
input the accepted outline prompt into a natural-language processing model to obtain a detailed prompt indicating detailed specifications regarding the program code; and
input the obtained detailed prompt into the natural-language processing model to obtain the program code.
